(19) United States
(12) Patent Application Publication
(10) Pub. No.: US 2020/0356122 A1
(43) Pub. Date: Nov. 12, 2020

(54) ALTERNATIVE FUEL ZERO PRESSURE REGULATOR

(71) Applicant: Century Fuel Products, LLC, Belleville, MI (US)

(72) Inventors: Gregory L. Nolff, Belleville, MI (US); Roger Larry Simons, Davidson, NC (US); Robert L. Nolff, Romulus, MI (US)

(73) Assignee: Century Fuel Products, LLC, Belleville, MI (US)

(21) Appl. No.: 16/517,572

(22) Filed: Jul. 20, 2019

Related U.S. Application Data
(60) Provisional application No. 62/845,182, filed on May 8, 2019.

(51) Int. Cl. G05D 16/06; F02M 21/02; G05D 7/06

(52) U.S. Cl. CPC G05D 16/0675; G05D 7/0635; F02M 21/0242; F02M 21/0239

(57) ABSTRACT

A system for controlling a gas fuel flow in a fuel delivery system includes an on-demand pressure regulator. The pressure regulator includes an internal diaphragm configured to provide the gas fuel flow from an outlet port of the pressure regulator within a desired pressure range and a cut-off valve selectively blocking the gas fuel flow through the pressure regulator.

### CROSS-REFERENCE TO RELATED APPLICATIONS

This disclosure claims priority from U.S. Provisional Application No. 62/845,182 filed on May 8, 2019, which is hereby incorporated by reference.

### TECHNICAL FIELD

This disclosure is related to a device useful to regulate fuel gas pressure, in particular, to a regulator device useful to regulate propane or natural gas pressure in an engine fuel supply system.

### BACKGROUND

The statements in this section merely provide background information related to the present disclosure. Accordingly, such statements are not intended to constitute an admission of prior art.

Pressure regulators are known in the art. They commonly utilize a diaphragm to automatically modulate a valve setting, thereby controlling a fuel gas pressure provided from a regulator outlet.

Electrically actuated solenoids and vacuum pressure activated valves are examples of cut-off valves known in the art. Either can be used to selectively open or close a fuel line. An electrically actuated solenoid or vacuum pressure activated valve is known to be used in series with a pressure regulator to provide improved control over a fuel gas flow to an engine. However, use of a separate regulator and cut-off valve can be problematic. Aftermarket attachment of a cut-off valve to a regulator can cause damage to the regulator port. Many cut-off valves known in the art include maximum pressure values below what can be experienced in fuel supply systems. Further, the body of the regulator and the body of the cut-off valve can each be rather bulky due to the substantial wall thicknesses that are required to contain the pressurized fuel gases. Use of separate regulators and cut-off valves can be space prohibitive within a confined space of an engine and can be particularly troublesome or prohibitive when retrofitting an engine from one fuel type to another.

### SUMMARY

According to one embodiment of the disclosure, a system for controlling a gas fuel flow in a fuel delivery system is provided including an on-demand pressure regulator. The on-demand pressure regulator includes an internal diaphragm configured to provide the gas fuel flow from an outlet port of the pressure regulator within a desired pressure range and a cut-off valve selectively blocking the gas fuel flow through the pressure regulator.

According to another embodiment of the disclosure, a system for controlling a gas fuel flow in a fuel delivery system includes an on-demand pressure regulator. The on-demand pressure regulator includes an internal diaphragm configured to provide the gas fuel flow from an outlet port of the pressure regulator within a desired pressure range and a cut-off valve selectively blocking the gas fuel flow through the pressure regulator. The system further includes a pressure switch configured to monitor pressure within the fuel delivery system and a computerized cut-off control module with programming to monitor data from the pressure switch, determine whether the data indicates that the monitored pressure exceeds a threshold cut-off pressure, and control the cut-off valve to selectively block the gas fuel flow based upon the determining.

According to another embodiment of the disclosure, a system for controlling a gas fuel flow in a fuel delivery system is provided including an on-demand pressure regulator. The on-demand pressure regulator includes a two-sided valve body, a pressure regulator valve comprising a pressure regulator valve seal configured to press against a first side of the two-sided valve body, an internal diaphragm connected to the pressure regulator valve, and a cut-off valve selectively blocking the gas fuel flow through the pressure regulator and comprising a cut-off valve seal configured to press against a second side of the two-sided valve body. The pressure regulator valve is configured to selectively restrict the gas fuel flow through the pressure regulator based upon gas pressure within the pressure regulator acting upon the diaphragm to provide the gas fuel flow from an outlet port of the pressure regulator within a desired pressure range.

### BRIEF DESCRIPTION OF THE DRAWINGS

One or more embodiments will now be described, by way of example, with reference to the accompanying drawings, in which:

FIG. 1 illustrates an external view of a prior art pressure regulator in a top view, in accordance with the present disclosure;

FIGS. 2A and 2B illustrate in side view cross sectional views of the pressure regulator of FIG. 1, illustrating internal pressure within the pressure regulator actuating a pressure regulation valve seal, in accordance with the present disclosure;

FIG. 3 illustrates in top view an external view of an exemplary embodiment of an improved pressure regulator, in accordance with the present disclosure;

FIG. 4 illustrates in side view an external view of the improved pressure regulator of FIG. 3, with an exemplary electric solenoid device attached to the improved pressure regulator, in accordance with the present disclosure;

FIG. 5 illustrates in alternative side view the improved pressure regulator of FIG. 3, illustrating the intake port, in accordance with the present disclosure;

FIG. 6 illustrates the improved pressure regulator of FIG. 4 in cross sectional view, illustrating internal components of the improved pressure regulator, in accordance with the present disclosure;

FIG. 7 illustrates in exploded perspective view select components of the improved pressure regulator of FIG. 6, including the pressure regulator valve seal, the cut-off valve seal, the two-sided valve body, and the plug washer, in accordance with the present disclosure;

FIG. 8 illustrates the improved pressure regulator of FIG. 6 in side cross sectional view, with both the pressure regulator valve seal and the cut-off valve seal disengaged from the two-sided valve body, such that a fuel flow can pass through the improved pressure regulator, in accordance with the present disclosure;

FIG. 9 illustrates the improved pressure regulator of FIG. 6 in side cross sectional view, with internal pressure within the improved pressure regulator depressing the diaphragm within the regulator body, thereby actuating the pressure regulator valve seal and fully or partially blocking fuel flow through the improved pressure regulator, in accordance with the present disclosure;

FIG. 10 illustrates the improved pressure regulator of FIG. 6 in side cross sectional view, with the electric solenoid controlling the cut-off valve seal locking the seal against the two-sided valve body thereby fully blocking flue flow through the improved pressure regulator, in accordance with the present disclosure;

FIG. 11 schematically illustrates a control system useful to monitor pressure within a fuel delivery system and actuate the cut-off valve seal within the improved pressure regulator as needed, in accordance with the present disclosure;

FIG. 12 illustrates an exemplary embodiment of a computerized cut-off valve control module useful to control the cut-off valve of the disclosed improved pressure regulator, in accordance with the present disclosure;

FIG. 13 illustrates in side cross sectional view an alternative exemplary embodiment of an improved pressure regulator, including a vacuum actuated cut-off valve seal, in accordance with the present disclosure;

FIG. 14 is a flow chart illustrating an exemplary process to activate a cut-off event of a fuel delivery system, in accordance with the present disclosure;

FIG. 15 illustrates an exemplary alternative embodiment of the improved pressure regulator of FIG. 6, with a pressed in two-sided valve body, in accordance with the present disclosure;

FIG. 16 illustrates an additional exemplary alternative embodiment of the improved pressure regulator of FIG. 6, with a two-sided valve body molded into the intake manifold, in accordance with the present disclosure;

FIG. 17 illustrates an exemplary alternative embodiment of the improved pressure regulator of FIG. 15, with an electrically driven rotary valve activating the cut-off valve, in accordance with the present disclosure; and

FIG. 18 illustrates an exemplary alternative embodiment of the improved pressure regulator of FIG. 15, with a manually operated valve activating the cut-off valve, in accordance with the present disclosure.

### DETAILED DESCRIPTION

An improved pressure regulator for use with fuel gases is provided. In one embodiment, the pressure regulator can be used to supply a desired fuel gas flow within a desired pressure range to an engine or a carburetor of an engine. In one embodiment of the improved pressure regulator, a cut-off valve such as an electrically actuated solenoid or a vacuum actuated cut-off valve can be build into the body of the pressure regulator. This cut-off valve can be formed integrally with the body of the pressure regulator, for example, at an intake port of the pressure regulator.

In another embodiment of the improved pressure regulator, an improved internal pressure regulator valve can be utilized to increase the range and/or sensitivity of the diaphragm response of the pressure regulator, for example, increasing a maximum fuel gas flow through the regulator and reducing a lag time of the regulator. In one embodiment, such improvement can be achieved by increasing pressure regulator valve rotational travel within the housing. In another embodiment, such improvement can be made by utilizing improved pressure regulator valve seals and sealing materials within the regulator body to make the pressure regulator valve more responsive. In known embodiments, a pressure regulator valve adjustment knob must be provided to aid customers/end users that need improved or altered flow control profiles for the regulator. However, such adjustments can change cause the engine to lose important emissions controls, such as can be required by EPA or California specific emissions standards. A benefit of the improved pressure regulator valve design can be that the adjustment knob can be removed and the valve can service all engine operation ranges with the factory set operation. Such factory set operation can include an engine specific spring internal to the regulator body, creating an engine specific fuel gas flow profile for the factory set regulator.

One embodiment can optionally include both an integrated pressure switch and an improved pressure regulator valve. Other embodiments can include only one of the two improvements.

In one embodiment, the pressure regulator valve and the cut-off valve can each seat against opposite ends of a two-sided valve body.

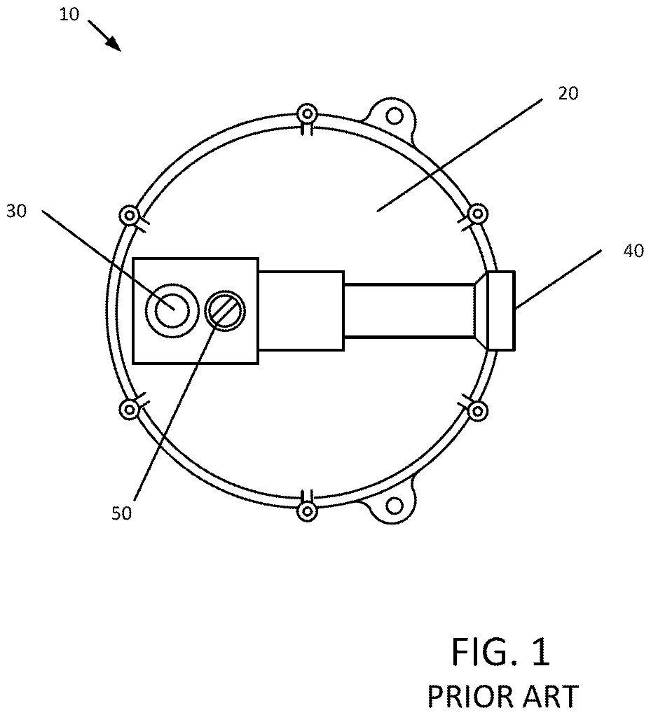

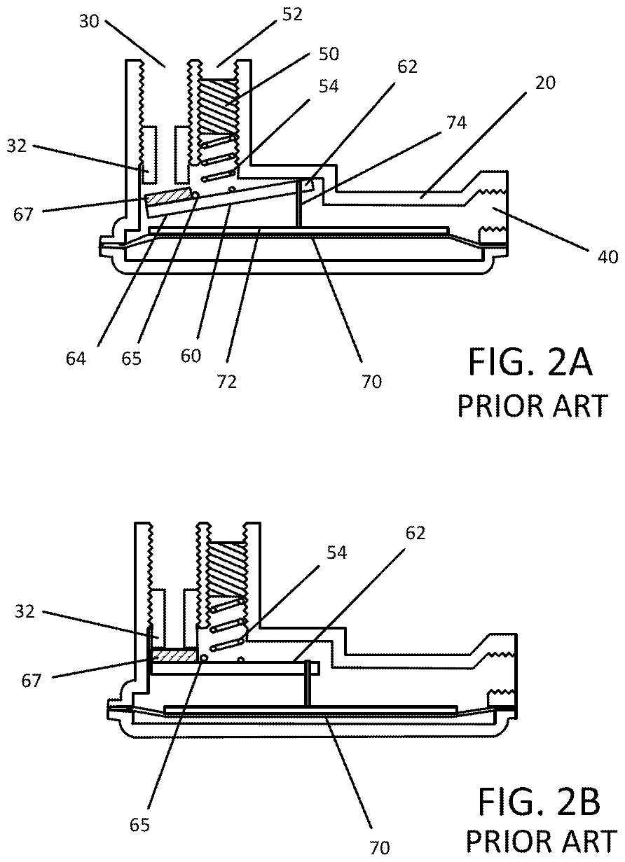

Referring now to the drawings, wherein the showings are for the purpose of illustrating certain exemplary embodiments only and not for the purpose of limiting the same, FIG. 1 illustrates an external view of a prior art pressure regulator in a top view. Pressure regulator 10 is illustrated including regulator chamber 20, intake port 30, outlet port 40, and spring adjustment point 50. Regulator chamber 20 is a disk shaped structure which encapsulates a diaphragm which is used to control a pressure regulator valve within regulator chamber 20. FIGS. 2A and 2B illustrate in side view cross sectional views of the pressure regulator of FIG. 1, illustrating internal pressure within the pressure regulator actuating a pressure regulation valve seal. The pressure regulator is illustrated including regulator chamber 20, intake port 30, outlet port 40, pivoting pressure regulator valve arm 60, pressure regulator valve spring 54, and diaphragm 70. Pivoting pressure regulator valve arm 60 pivots about hinge 65 and can either permit valve body 32 to be open, permitting fuel flow there through, or block valve body 32 by seating pressure regulator valve seal 67 attached to second end 64 of pivoting pressure regulator valve arm 60 against valve body 32. FIG. 2A illustrates the pressure regulator valve seal 67 in an open position, and FIG. 2B illustrates the pressure regulator valve seal 67 in an closed position.

A first end 62 of pivoting pressure regulator valve arm 60 is acted upon by opposing forces, a force from pressure regulator valve spring 54 pulling first end 62 upward and a force from diaphragm linkage 74, pulling first end 62 downward. Gas pressure within regulator chamber resulting from the pressurized flow entering the pressure regulator acts upon diaphragm 70. An area under diaphragm 70 is filled with gas at a calibrated pressure. Depending upon the gas pressure of the fuel above diaphragm 70, diaphragm 70 can pull downwardly upon diaphragm linkage 74 which in turn pulls down upon first end 62. Based upon the gas pressure of the calibrated pressure under the diaphragm and the force exerted by pressure regulator valve spring 54, pivoting pressure regulator valve arm 60 can be set to close off valve body 32 at a desired fuel pressure, thereby stopping gas pressure of the flow from getting too high.

Diaphragm 70 forms a gas seal between the area above diaphragm 70 and below diaphragm 70 and is frequently constructed of a pliable plastic or rubberized material. Diaphragm plunger 72 can be provided to provide rigidity to the diaphragm and provide an attachment point to avoid diaphragm linkage 74 from tearing the pliable material of diaphragm 70.

Spring adjustment point 50 is provided within threaded cavity 52 to permit adjustment of spring force in pressure regulator valve spring 54. In known configurations of pressure regulator valves, spring adjustment point 50 is needed to enable a factory to set a desired maximum pressure for the pressure regulator valve. However, such an ability to adjust the pressure regulator valve can be problematic, as any mechanic or vehicle operator can adjust the valve settings. Such non-factory adjustments can cause performance or emissions issues with the associated combustion engine.

Pressure regulator 10 can be problematic for other reasons. Pressure regulator valve seat 67 can only handle moderate spikes in fuel pressure and may leak when a larger spike occurs. Further, pressure regulators are used frequently to retrofit engines that were originally not intended to use propane or natural gas fuel. Cut-off valves are useful to provide protection against large pressure spikes and enabling a computerized control module to immediately shut off a fuel flow. Cut-off valves provided in retrofit kits may or may not be successfully attached to the fuel system, thereby raising issues related to improperly assembled retrofit engines.

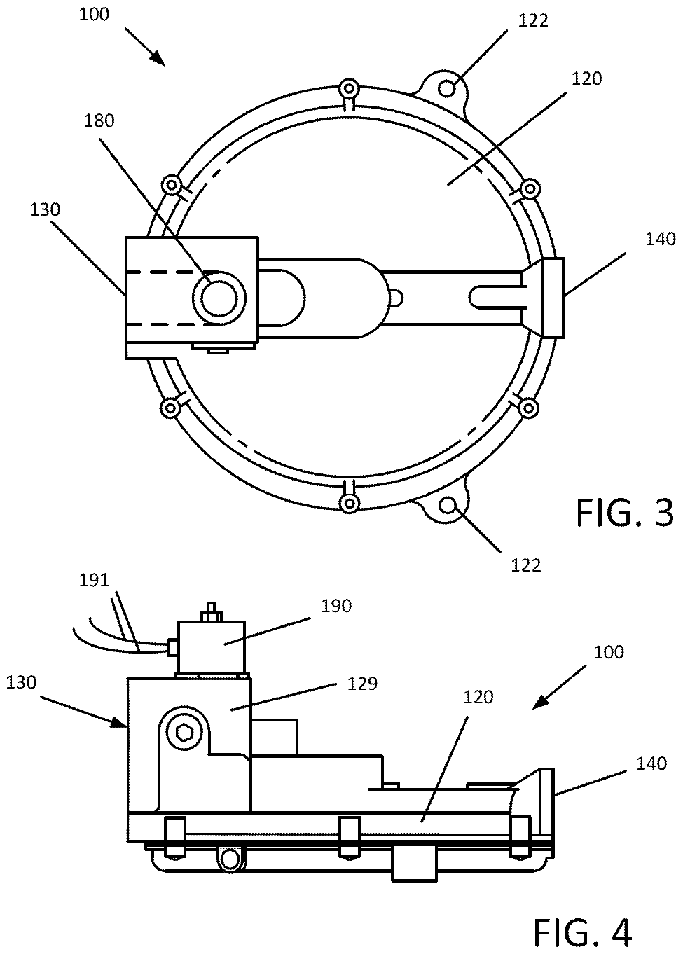

FIG. 3 illustrates in top view an external view of an exemplary improved pressure regulator. Pressure regulator 100 is illustrated including regulator chamber 120, intake port 130, outlet port 140, and cut-off valve cavity 180. Optional mounting bosses 122 are further provided. Regulator chamber 120 is a disk shaped structure which encapsulates a diaphragm which is used to control a pressure regulator valve within regulator chamber 120.

FIG. 4 illustrates in side view an external view of the improved pressure regulator of FIG. 3, with an exemplary electric solenoid device attached to the improved pressure regulator. Pressure regulator 100 is illustrated including regulator chamber 120, intake manifold 129, intake port 130, outlet port 140, and an exemplary electric solenoid 190 attached and assembled to the cut-off valve cavity of FIG. 1. Electric solenoid 190 is configured to selectively allow and block flow of fuel through the pressure regulator by applying electric power to electric solenoid 190 through electric wires 191.

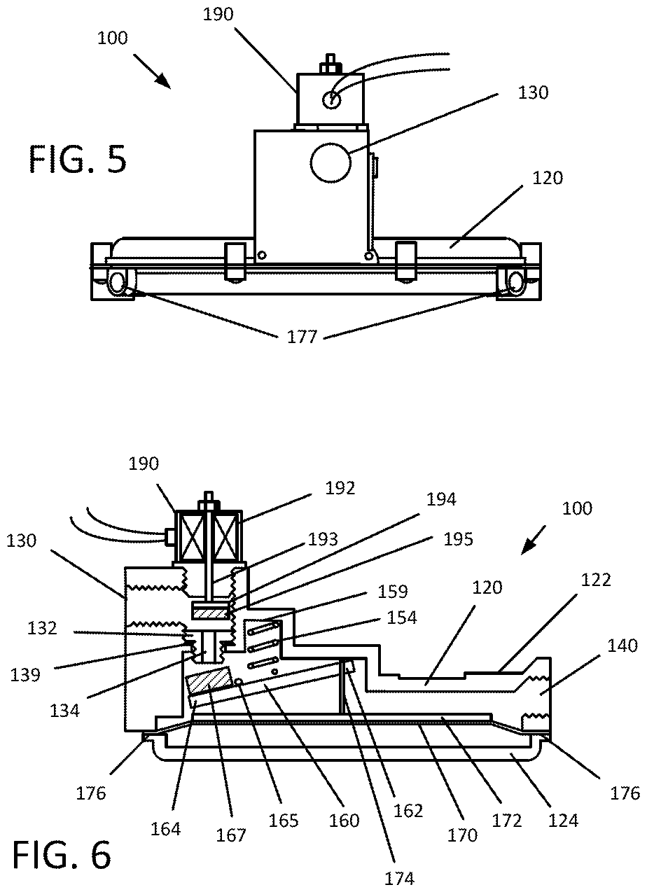

FIG. 5 illustrates in alternative side view the improved pressure regulator of FIG. 3, illustrating the intake port. Pressure regulator 100 is illustrated including regulator chamber 120, intake port 130, and solenoid 190. Two exemplary ports 177 are provided for controlling pressure under a diaphragm within regulator chamber 120.

FIG. 6 illustrates the improved pressure regulator of FIG. 4 in cross sectional view, illustrating internal components of the improved pressure regulator. Pressure regulator 100 is illustrated including regulator chamber 120, intake port 130, outlet port 140, pivoting pressure regulator valve arm 160, pressure regulator valve spring 154, and diaphragm 170. Pivoting pressure regulator valve arm 160 pivots about hinge 165 and can either permit two-sided valve body 132 to be open, permitting fuel flow there through, or block two-sided valve body 132 by seating pressure regulator valve seal 167 attached to second end 164 of pivoting pressure regulator valve arm 160 against two-sided valve body 132. FIG. 6 illustrates the pressure regulator valve seal 167 in an open position. Electric solenoid 190 is illustrated including electro-magnetic coils 192 which control a vertical position of solenoid plunger 193. Solenoid plunger 193 is attached to plunger disk 194 which is attached to cut-off valve seal 195. By controlling electric solenoid 190, cut-off valve seal 195 can be selectively kept away from two-sided valve body 132, permitting fuel to flow through pressure regulator 100, or firmly seated against two-sided valve body 132, blocking fuel from flowing through pressure regulator 100. Testing has shown that such a solenoid activated cut-off valve seal 195 can seal the pressure regulator against a wide range of pressure spikes.

Two-sided valve body 132 is configured to be installed into an exemplary threaded cavity within the intake manifold. Two-sided valve body 132 includes a central cavity 134 which normally permits fuel to flow through two-sided valve body 132. Valve body washer 139 can be provided as a rubberized part useful to seal two-sided valve body 132 to the cavity walls within the intake manifold. In one embodiment, valve body washer 139 can include one or more polymer o-rings. Regulator chamber 120 is formed with a disk shaped upper housing 122 and a mating disk shaped lower housing 124. Upper housing 122 and lower housing 124 can be fastened together, according to one exemplary embodiment, with a plurality of fasteners located around a perimeter of regulator chamber 120.

Pressure regulator valve spring 154 can be adjustable as illustrated in the pressure regulator of FIG. 1. In one exemplary embodiment, as illustrated in FIG. 6, a dedicated, non-adjustable spring can be pre-selected for a desired fuel system performance for a particular combustion engine. As a result, pressure regulator valve spring 154 can be set within pressure regulator 100 and not include an adjustment feature.

A first end 162 of pivoting pressure regulator valve arm 160 is acted upon by opposing forces, a force from pressure regulator valve spring 154 pulling first end 162 upward and a force from diaphragm linkage 174, pulling first end 162 downward. As fuel is pressurized within regulator chamber, it acts upon diaphragm 170. An area under diaphragm 170 is filled with gas at a calibrated pressure. Depending upon the pressure of the fuel above diaphragm 170, diaphragm 170 can pull downwardly upon diaphragm linkage 174 which in turn pulls down upon first end 162. Based upon the pressure of the calibrated pressure under the diaphragm and the force exerted by pressure regulator valve spring 154, pivoting pressure regulator valve arm 160 can be set to close off valve body 132 at a desired fuel pressure, thereby stopping fuel pressure from getting too high.

Diaphragm 170 forms a gas seal between the area above diaphragm 170 and below diaphragm 170 and is frequently constructed of a pliable plastic or rubberized material. Diaphragm plunger 172 can be provided to provide rigidity to the diaphragm and provide an attachment point to avoid diaphragm linkage 174 from tearing the pliable material of diaphragm 170. Diaphragm 170 can be sealed to the walls of regulator chamber 120 by gripping an outer ring 176 of diaphragm 170 between upper housing 122 and lower housing 124.

Electric solenoid 190, solenoid plunger 193, plunger disk 194, cut-off valve seal 195 and two-sided valve body 132 can collectively be described as a cut-off valve or an electric solenoid activated cut-off valve.

Pressure regulator valve spring 154 can be specifically selected for a particular vehicle engine and the precise desired pressure range for that engine. Pressure regulator valve spring 154 is seated against a closed end cavity 159 configured to prevent adjustment of the spring.

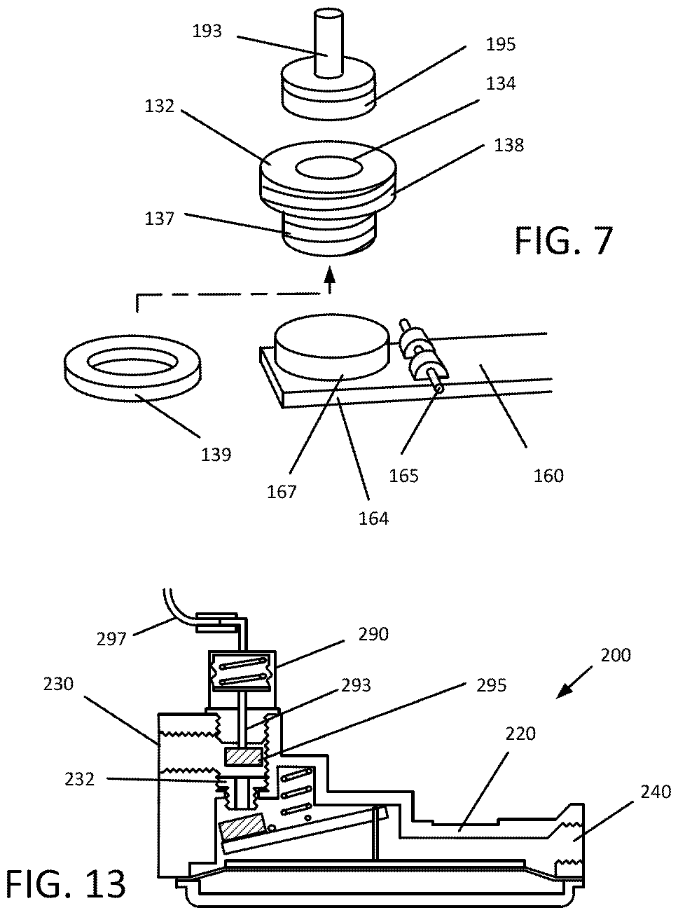

FIG. 7 illustrates in exploded perspective view select components of the improved pressure regulator of FIG. 6 in magnified detail, including the pressure regulator valve seal, the cut-off valve seal, the two-sided valve body, and the valve body washer. Solenoid plunger 193 is illustrated, including cut-off valve seal 195. Pivoting pressure regulator valve arm 160 is illustrated including hinge 165, second end 164, and pressure regulator valve seal 167. Two-sided valve body 132 is illustrated, including central cavity 134, a wider threaded upper portion 138 and a narrower threaded lower portion 137. In one embodiment, only one of upper portion 138 and lower portion 137 need to be threaded. An upper surface of upper portion 138 is flat and configured to seal against a lower surface of cut-off valve seal 195. A lower surface of lower portion 137 is flat and configured to seal against an upper surface of pressure regulator valve seal 167. Valve body washer 139 is illustrated and can be assembled, as illustrated by the arrow notation, to the lower portion 137 to create a seal against a mating cavity within the intake manifold. In one alternative embodiment, either the top surface of upper portion 138 or the lower surface of lower portion 137 can include a raised annular ridge configured to dig into the mating seal and improve sealing ability.

Pivoting pressure regulator valve arm 160, first end 162, hinge 165, second end 164, pressure regulator valve seal 167, and two-sided valve body 132 can collectively be described as a pressure regulator valve.

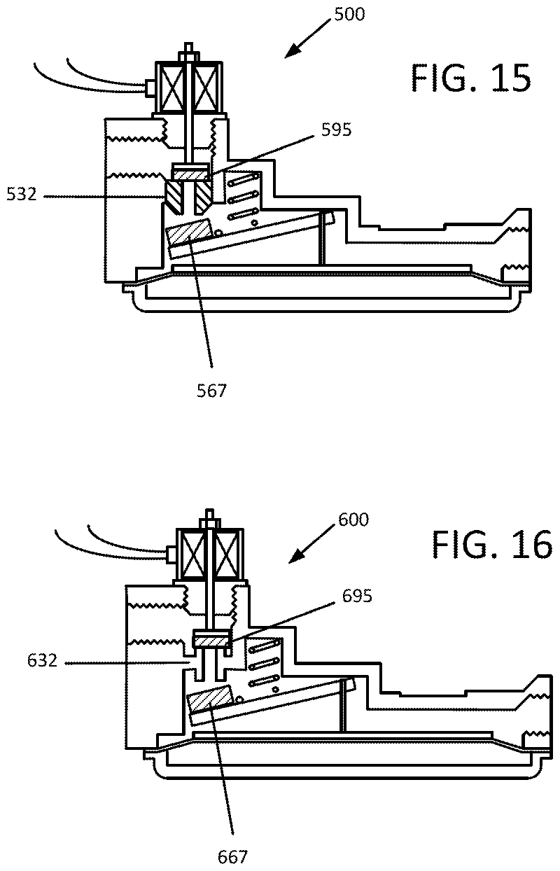

Two-sided valve body 132 is illustrated including threads useful to screw the two-sided valve body into place within the intake manifold of pressure regulators herein. It will be appreciated that in some embodiments the two-sided valve body can be configured to be pressed into a cavity within the pressure regulator, for example, with dimensions in the two-sided valve body and the cavity creating an interference fit, where the two-sided valve body, once pressed into place, is held firmly in place. FIG. 15 illustrates an exemplary alternative embodiment of the improved pressure regulator of FIG. 6, with a pressed in two-sided valve body. Pressure regulator 500 is illustrated including two-sided valve body 532 being pressed into a cavity within the intake manifold of the pressure regulator. Cut-off valve seal 595 is positioned to selectively press against a top side of two-sided valve body 532, and pressure regulator valve seal 567 is positioned to selectively press against a bottom side of two-sided valve body 532.

In another embodiment, the two-sided valve body can be cast into the intake manifold or body of the pressure regulator, being formed unitarily therewith. FIG. 16 illustrates an additional exemplary alternative embodiment of the improved pressure regulator of FIG. 6, with a two-sided valve body molded into the intake manifold, in accordance with the present disclosure. Pressure regulator 600 is illustrated including two-sided valve body 632 being formed integrally with the material of the body of pressure regulator 600. Cut-off valve seal 695 is positioned to selectively press against a top side of two-sided valve body 632, and pressure regulator valve seal 667 is positioned to selectively press against a bottom side of two-sided valve body 632.

Two-sided valve body 132 can be provided with a number of different diameters of central cavity, for example, including inner diameters of three-eights of an inch, seven-sixteenths of an inch, and one-half of an inch. These different orifice dimensions of the two-sided valve body 132 can be useful to control the performance characteristics of the pressure regulator.

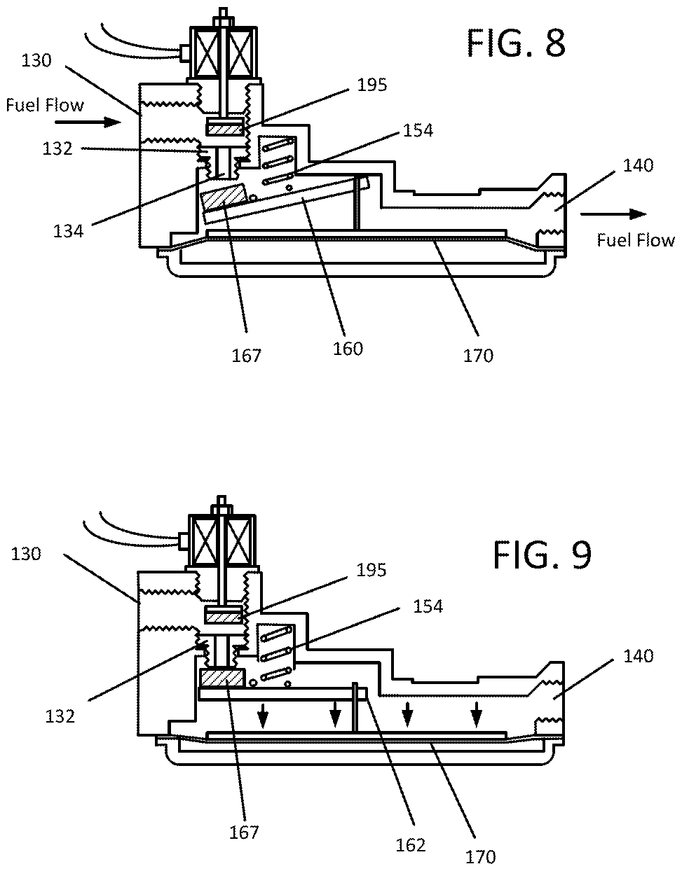

FIG. 8 illustrates the improved pressure regulator of FIG. 6 in side cross sectional view, with both the pressure regulator valve seal and the cut-off valve seal disengaged from the two-sided valve body, such that a fuel flow can pass through the improved pressure regulator. The pressure regulator is illustrated including cut-off valve seal 195 in a position away from two-sided valve body 132 and including pressure regulator valve seal 167 in a position away from two-sided valve body 132, such that a fuel flow can pass through central cavity 134 of two-sided valve body 132. Internal pressure within the regulator chamber above diaphragm 170 are insufficient to counteract the upward force applied to pivoting pressure regulator valve arm 160 by pressure regulator valve spring 154, such that pressure regulator valve seal 167 is held away from two-sided valve body 132. Additionally, electronic control of the solenoid is illustrated such that cut-off valve seal 195 is similarly held away from two-sided valve body 132. The pressure regulator can be said to be in an open state or operational state, with a fuel flow passing from intake port 130, through the two-sided valve body 132, out of outlet port 140.

FIG. 9 illustrates the improved pressure regulator of FIG. 6 in side cross sectional view, with internal pressure within the improved pressure regulator depressing the diaphragm within the regulator body, thereby actuating the pressure regulator valve seal and fully or partially blocking fuel flow through the improved pressure regulator. The pressure regulator is illustrated including cut-off valve seal 195 in a position away from two-sided valve body 132. However, pressure within the regulator chamber, represented by four illustrated arrows above diaphragm 170, is great enough to overcome the upward force applied by pressure regulator valve spring 154. As a result, first end 162 of the pivoting pressure regulator valve arm is pulled downward, and the pressure regulator valve seal 167 is pressed upward against two-sided valve body 132. In one embodiment, this upward pressure by pressure regulator valve seal 167 can completely block fuel flow through two-sided valve body 132. In another embodiment, this upward pressure reduces fuel flow through two-sided valve body 132 to a degree that pressure within the regulator chamber stays at a current level or drops. As a result, the pressure regulator can be said to be in a regulated state or maximum pressure state, with no or a reduced amount of fuel flowing from intake port 130 to outlet port 140. In such a regulated state, the system can be said to include a diaphragm configured to provide a flow of fuel gas from an outlet port within a desired pressure range.

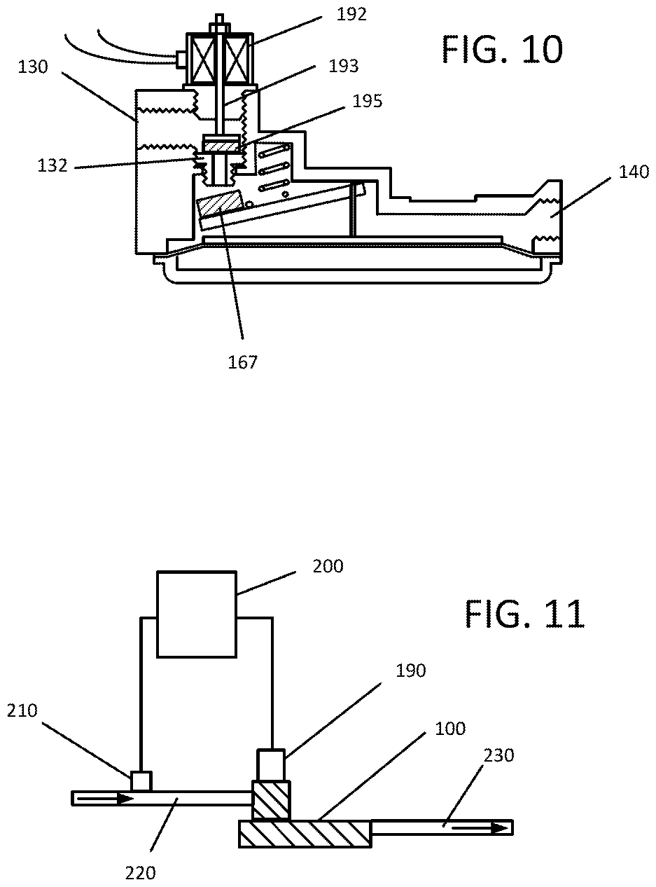

FIG. 10 illustrates the improved pressure regulator of FIG. 6 in side cross sectional view, with the electric solenoid controlling the cut-off valve seal locking the seal against the two-sided valve body thereby fully blocking flue flow through the improved pressure regulator. The pressure regulator is illustrated including pressure regulator valve seal 167 in a position away from two-sided valve body 132. However, cut-off valve seal 195 is illustrated pressed firmly against two-sided valve body 132 and blocking all fuel flow through two-sided valve body 132. The pressure regulator can be said to be in a locked state or a cut-off state, with no fuel flow passing from intake port 130 to outlet port 140.

FIG. 11 schematically illustrates a control system useful to monitor pressure within a fuel delivery system and actuate the cut-off valve seal within the improved pressure regulator as needed. Computerized cut-off control module 200 is illustrated in electronic communication with a pressure gage 210 configured to monitor a pressure within a fuel delivery system and in electronic communication with an electric solenoid 190 attached to improved pressure regulator 100. A fuel flow is illustrated flowing through regulator intake line 220 and through regulator outlet line 230. Pressure gage 210 can be located at many different locations in along or in gas pressure communication with the fuel deliver system including intake line 220 and outlet line 230. In one embodiment, pressure gate 210 can be attached to pressure regulator 100.

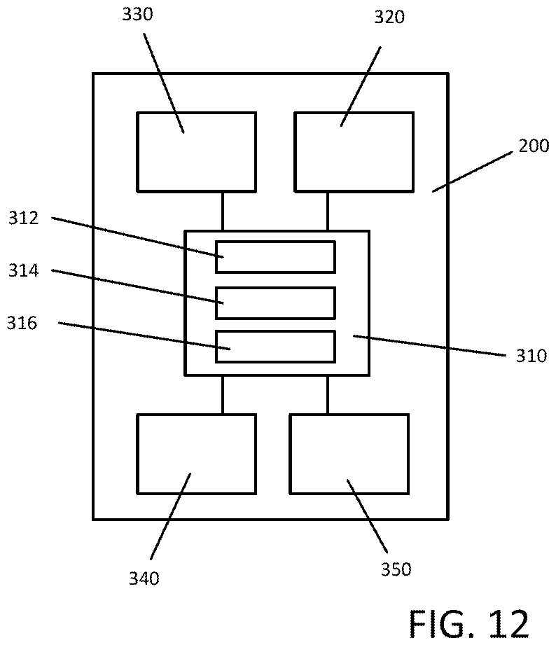

FIG. 12 illustrates an exemplary embodiment of a computerized cut-off valve control module useful to control the cut-off valve of the disclosed improved pressure regulator. Cut-off control module 200 may include processing device 310 configured to operate computerized programming. In the illustrative embodiment illustrating optional features of the disclosed system, cut-off control module 200 includes processing device 310, a control interface 330, a communications device 320, a memory device 350, a valve control interface 340. It is noted that cut-off control module 200 may include other components and some of the components are not present in some embodiments.

The processing device 310 may include memory, e.g., read only memory (ROM) and random-access memory (RAM), storing processor-executable instructions and one or more processors that execute the processor-executable instructions. In embodiments where the processing device 310 includes two or more processors, the processors may operate in a parallel or distributed manner. Processing device 310 may execute the operating system of the cut-off control module 200. Processing device 310 may include one or more modules executing programmed code or computerized processes or methods including executable steps. Illustrated modules may include a single physical device or functionality spanning multiple physical devices. In the illustrative embodiment, the processing device 310 includes pressure monitoring and comparison program module 312, cut-off criteria module 314, and valve control module 316 which are described in greater detail below.

The control interface 330 is a device that allows a user to interact with the cut-off control module 200. Control interface can include protocols, display screens, and programming mechanisms to permit a factory or maintenance technician to set parameters for cut-off events. While one control interface 330 is shown, the term “user interface” may include, but is not limited to, a touch screen, a physical keyboard, a mouse, a microphone, a speaker, and other user interface devices in the art.

The communications device 320 may include a communications/data connection with a bus device configured to transfer data to different components of the system and may include one or more wireless transceivers for performing wireless communication.

The memory device 350 is a device that stores data generated or received by the cut-off control module 200. The memory device 350 may include, but is not limited to, a hard disc drive, an optical disc drive, and/or a flash memory drive.

The valve control interface 340 can include programming and data output or direct control over a valve control device such as an electric solenoid or a vacuum control system useful to control a vacuum driven actuator.

Pressure monitoring and comparison program module 312 is provided as a programming module configured to monitor inputs from a pressure gage or gages configured to monitor pressure within a fuel delivery system and compare the monitored pressure readings to threshold values or ranges.

Cut-off criteria module 314 receives information from pressure monitoring and comparison program module 312 and makes a determination whether a cut-off event is authorized based upon the data. Cut-off criteria module 314 can further determine whether, after a cut-off event, fuel flow should later be automatically restored or whether the fuel should remain cut-off until a technician can be called.

Valve control module 316 can include programming to control valve control devices, for example, sending commands to valve control interface 340 regarding voltages to be applied to a solenoid or when to activate a vacuum control system.

Cut-off control module 200 is provided as an exemplary computerized device capable of executing programmed code to operate a cut-off valve in association with a fuel delivery system. A number of different embodiments of cut-off control module 200, devices attached thereto, and modules operable therein are envisioned, and the disclosure is not intended to be limited to examples provided herein. Cut-off control module 200 can be a circuit board device that can be physically located upon the pressure regulator, physically located upon or with the pressure gage, or elsewhere in the vehicle.

FIG. 13 illustrates in side cross sectional view an alternative exemplary embodiment of an improved pressure regulator, including a vacuum actuated cut-off valve seal. Improved pressure regulator 200 is illustrated including regulator chamber 220, intake port 230, outlet port 240, and vacuum actuated control device 290. Vacuum actuated control device 290 can include a vacuum line 297 providing control over extension and retraction of vacuum plunger 293 including cut-off valve seal 295. Vacuum actuated control device 290 can include an internal spring providing an extension force which can be overcome by vacuum or low pressure provided by vacuum line 297. By selective application or non-application of vacuum through vacuum line 297, the system can selectively keep cut-off valve seal 295 away from two-sided valve body 232, thereby permitting fuel to flow through pressure regulator 200, or firmly press cut-off valve seal 295 against two-sided valve body 232, thereby preventing fuel from flowing through pressure regulator 200.

Vacuum actuated control device 290 operates by changing pressure within the device as compared to ambient air pressure, and the changed pressure within the device acts to move the internal plunger and attached vacuum plunger 293 such that the desired movement of the plunger is achieved. Vacuum actuated control device 290 can alternatively be described as a pressure actuated control device.

Vacuum actuated control device 290, vacuum plunger 293, cut-off valve seal 295 and two-sided valve body 232 can collectively be described as a cut-off valve or an vacuum actuated cut-off valve.

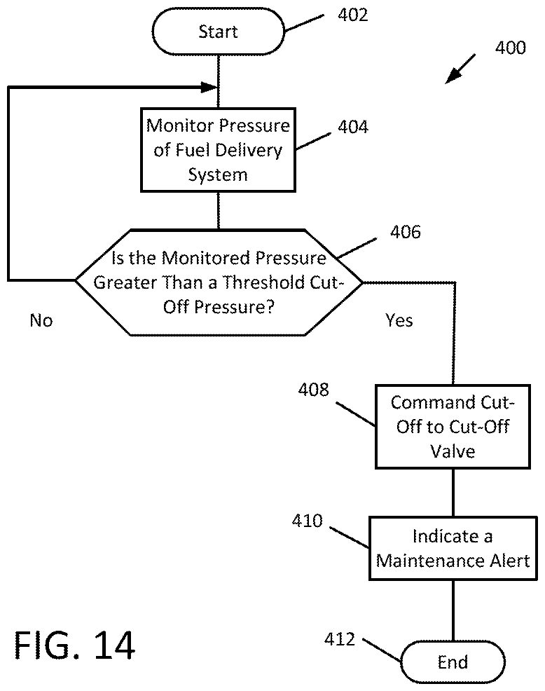

FIG. 14 is a flow chart illustrating an exemplary process to activate a cut-off event of a fuel delivery system. Process 400 starts at step 402. At step 404. the system monitors pressure in the fuel delivery system. At step 406, the system determines whether a monitored pressure value is greater than a threshold cut-off pressure value. If the monitored pressure value is not greater than the threshold value, the process returns to step 404 where the system continues to monitor the pressure readings. If the monitored pressure value is greater than the threshold cut-off pressure value, then the process advances to step 408 where a cut-off event is commanded to the cut-off valve. At step 410, an alert is indicated, recommending that maintenance worker be called to address the cause of the overly high pressure in the fuel delivery system. At step 412, the process ends. A number of alternative and/or additional process steps are envisioned, for example, commanding a cut-off event when the ignition of the vehicle is turned into an off position.

The disclosed system is described as being useful with a vehicle system. It will be appreciated that the disclosed system can be equally useful in a stationary power plant or other similar system.

The disclosed pressure regulator includes an intake port. Components of the fuel delivery system attached to the intake port can be described as being upstream of the pressure regulator. The disclosed pressure regulator includes an outlet port. Components of the fuel deliver system attached to the outlet port can be described as being downstream of the pressure regulator.

As described herein, a diaphragm and attached pressure regulator valve can be useful to provide a gas fuel flow at a constant or near constant pressure when an upstream gas pressure exceeds a gas pressure that causes the diaphragm to overcome the pressure regulator valve spring and restrict flow through the two-sided valve body. This type of pressure regulator with an ability of the pressure regulator valve to actuate in a way to partially restrict flow and continue to provide a gas fuel flow in a desired pressure range can be described as an on-demand pressure regulator.

As illustrated in FIG. 8, a gas fuel flow enters through intake port 130. Under high pressure conditions where a cut-off command to the cut-off valve may be appropriate to protect the engine or other components downstream of the pressure regulator, when the cut-off valve seal is extended and pressed firmly against the two-sided valve body, as is illustrated in FIG. 10, the high pressure of the gas fuel flow upstream of the pressure regulator acts or presses upon the cut-off valve seal. This force upon the cut-off valve seal presses the cut-off valve seal even more firmly against the two-sided valve body. This additional sealing pressure that the upstream gas fuel flow exerts on the cut-off valve seal assists in holding the seal against leaking gas past the seal. This type of valve can be described as a pressure assisted cut-off valve.

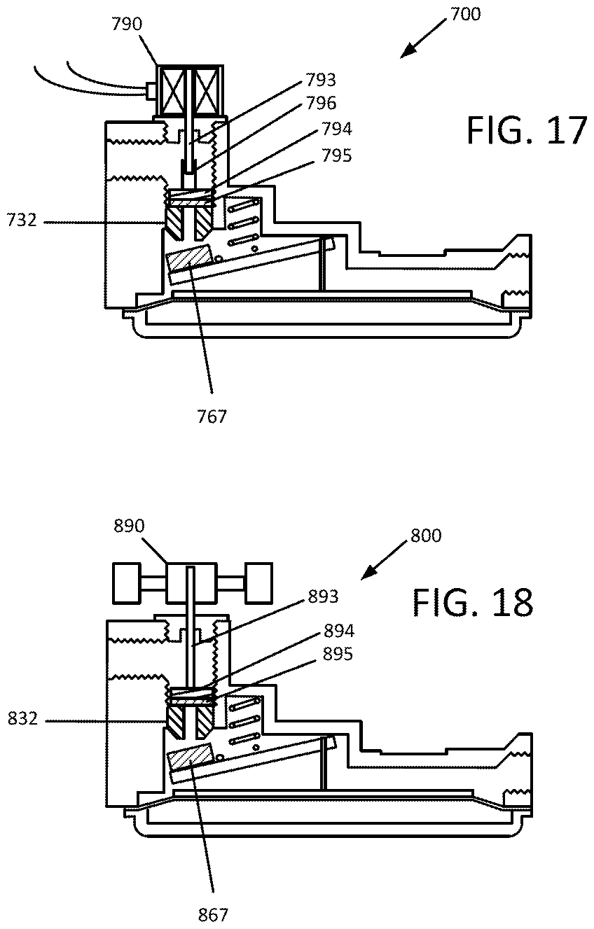

FIG. 17 illustrates an exemplary alternative embodiment of the improved pressure regulator of FIG. 15, with an electrically driven rotary valve activating the cut-off valve. Pressure regulator 700 is illustrated including two-sided valve body 732 being pressed into a cavity within the intake manifold of the pressure regulator. Cut-off valve seal 795 is positioned to selectively press against a top side of two-sided valve body 732, and pressure regulator valve seal 767 is positioned to selectively press against a bottom side of two-sided valve body 732. Rotary valve 790 is illustrated connected to pressure regulator 700, wherein electrical power applied to rotary valve 790 can 793, be used to turn exemplary inner valve shaft 793. In one exemplary embodiment, inner valve shaft 793 can include a key groove which is configured to mate with a key groove in outer valve shaft 796, such that when torque is applied to inner valve shaft 793, outer valve shaft 796 also turns. When combined with threaded features on an outer diameter of plunger disk 794 mating with threading upon an inner surface of the intake manifold of pressure regulator 700, the turning of inner valve shaft 793 causes the turning and extension of outer valve shaft 796 and the attached plunger disk 794. As plunger disk 794 extends, it causes cut-off valve seal 795 to selectively seat against two-sided valve body 732. Pressure regulator 700 including rotary valve 790, inner valve shaft 793, and outer valve shaft 794 illustrate one exemplary way in which an electric rotary valve can be used to implement a cut-off valve. A number of embodiments are envisioned, and the disclosure is not intended to be limited to the examples provided herein.

FIG. 18 illustrates an exemplary alternative embodiment of the improved pressure regulator of FIG. 15, with a manually operated valve activating the cut-off valve. Pressure regulator 800 is illustrated including two-sided valve body 832 being pressed into a cavity within the intake manifold of the pressure regulator. Cut-off valve seal 895 is positioned to selectively press against a top side of two-sided valve body 832, and pressure regulator valve seal 867 is positioned to selectively press against a bottom side of two-sided valve body 832. Manually operated valve 890 is illustrated connected to pressure regulator 800, wherein a user may turn hand crank 890 which in turn turns valve shaft 893. When combined with threaded features on an outer diameter of plunger disk 894 mating with threading upon an inner surface of the intake manifold of pressure regulator 800, the turning of valve shaft 893 and the attached plunger disk 894 cause plunger disk 894 and the attached cut-off valve seal 895 to extend and selectively seal against two-sided valve body 832. Pressure regulator 800 including hand crank 890 and valve shaft 893 illustrate one exemplary way in which a manually operated valve can be used to implement a cut-off valve. A number of embodiments are envisioned, and the disclosure is not intended to be limited to the examples provided herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A system for controlling a gas fuel flow in a fuel delivery system, comprising:
an on-demand pressure regulator comprising:
an internal diaphragm configured to provide the gas fuel flow from an outlet port of the pressure regulator within a desired pressure range; and
a cut-off valve including an electric solenoid selectively blocking the gas fuel flow through the pressure regulator;
an intake line operable to deliver the gas fuel flow to the on-demand pressure regulator; and
a pressure switch connected to the intake line and configured to monitor pressure within the intake line; and
wherein the cut-off valve is controlled based upon the monitored pressure and in order to protect the on-demand pressure regulator from a pressure spike in the intake line.

2. The system of claim 1, wherein the cut-off valve being controlled based upon the monitored pressure comprises the cut-off valve blocking the gas fuel flow through the pressure regulator based upon the monitored pressure exceeding a threshold cut-off pressure value.

4. (canceled)

5. The system of claim 1, wherein the cut-off valve comprises a vacuum actuated cut-off valve.

6. The system of claim 1, wherein the diaphragm is connected to a pressure regulator valve configured to selectively restrict the gas fuel flow through the pressure regulator based upon gas pressure within the pressure regulator acting upon the diaphragm;
further comprising a two-sided valve body;
wherein the pressure regulator valve comprises a pressure regulator valve seal configured to press against the two-sided valve body; and
wherein the cut-off valve comprises a cut-off valve seal configured to press against the two-sided valve body.

7. The system of claim 6, wherein the pressure regulator valve further comprises:
a pivoting pressure regulator valve arm, comprising:
a first end connected to the diaphragm with a diaphragm linkage;
a second end connected the pressure regulator valve seal; and
a hinge between the first end and the second end; and
a pressure regulator valve spring acting upon the pivoting pressure regulator valve arm.

8. The system of claim 7, wherein the pressure regulator valve spring is seated against a closed end cavity configured to prevent adjustment of the pressure regulator valve spring.

9. The system of claim 6, wherein the cut-off valve comprises a pressure assisted cut-off valve, wherein gas pressure within the intake port presses the cut-off valve seal against the two-sided valve body.

10. The system of claim 6, wherein the two-sided valve body comprises threads.

11. The system of claim 1, wherein the cut-off valve comprises an electric rotary valve.

12. The system of claim 1, wherein the cut-off valve comprises a manually operated valve.

13. A system for controlling a gas fuel flow in a fuel delivery system, comprising:
an on-demand pressure regulator comprising:
an internal diaphragm configured to provide the gas fuel flow from an outlet port of the pressure regulator within a desired pressure range; and
a cut-off valve including an electric solenoid selectively blocking the gas fuel flow through the pressure regulator;
an intake line operable to deliver the gas fuel flow to the on-demand pressure regulator;
a pressure switch configured to monitor pressure within the intake line; and
a computerized cut-off control module, with programming to:
monitor data from the pressure switch;
determine whether the data indicates that the monitored pressure exceeds a threshold cut-off pressure; and
control the cut-off valve to selectively block the gas fuel flow based upon the determining and in order to protect the on-demand pressure regulator.

14. A system for controlling a gas fuel flow in a fuel delivery system, comprising:
an on-demand pressure regulator comprising:
a two-sided valve body;
a pressure regulator valve comprising a pressure regulator valve seal configured to press against a first side of the two-sided valve body;
an internal diaphragm connected to the pressure regulator valve; and
a cut-off valve including an electric solenoid selectively blocking the gas fuel flow through the pressure regulator and comprising a cut-off valve seal configured to press against a second side of the two-sided valve body;
an intake line operable to deliver the gas fuel flow to the on-demand pressure regulator; and
a pressure switch connected to the intake line and configured to monitor pressure within the intake line; and
wherein the pressure regulator valve is configured to selectively restrict the gas fuel flow through the pressure regulator based upon gas pressure within the pressure regulator acting upon the diaphragm to provide the gas fuel flow from an outlet port of the pressure regulator within a desired pressure range; and
wherein the cut-off valve is controlled based upon the monitored pressure and in order to protect the on-demand pressure regulator from a pressure spike in the intake line.
